(19) United States
(12) Patent Application Publication
(10) Pub. No.: US 2025/0039737 A1
(43) Pub. Date: Jan. 30, 2025

(54) NR UDC - FLEXIBLE DRB SWITCH

(71) Applicant: Nokia Technologies Oy, Espoo (FI)

(72) Inventors: Jing HE, Beijing (CN); Ping YUAN, Beijing (CN)

(21) Appl. No.: 18/708,414

(22) PCT Filed: Nov. 9, 2021
(86) PCT No.: PCT/CN2021/129449

§ 371 Date: May 8, 2024

(51) Int. Cl. H04W 28/06; H04W 72/1268; H04W 76/19

(52) U.S. Cl. CPC H04W 28/06; H04W 72/1268; H04W 76/19

(57) ABSTRACT

A plurality of DRBs may be configured for UDC. The DRBs configured for UDC may only be activated for UDC operation upon UE request. The UE may cause selected DRBs to be activated for UDC operation using an uplink RRC message, a user plane control PDU, or a PDCP/SDAP header in a data PDU. A base station may transmit, to a UE, a UDC configuration configuring one or more DRBs to support UDC for the UE without initial UDC operation activation; receive, from the UE, an indication to activate at least one DRB with UDC configured for UDC operation; and, in response to the indication, at least one of: perform, locally, a PDCP entity re-establishment procedure associated with the at least one DRB, or inform the UE to perform a PDCP entity re-establishment procedure associated with the at least one DRB.

### TECHNICAL FIELD

The example and non-limiting embodiments relate generally to uplink communication and, more particularly, to uplink data compression.

### BACKGROUND

It is known, in UDC, to specify a static maximum number of DRBs for UDC configuration.

### SUMMARY

The following summary is merely intended to be illustrative. The summary is not intended to limit the scope of the claims.

In accordance with one aspect, an apparatus comprising: at least one processor; and at least one memory including computer program code; the at least one memory and the computer program code configured to, with the at least one processor, cause the apparatus at least to: transmit, to a user equipment, an uplink data compression configuration, wherein the uplink data compression configuration configures one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

In accordance with one aspect, a method comprising: transmitting, to a user equipment, an uplink data compression configuration, wherein the uplink data compression configuration configures one or more data radio bearers to support uplink data compression for the user equipment without initial uplink data compression operation activation; receiving, from the user equipment, an indication to activate at least one data radio bearer of the one or more data radio bearers with uplink data compression configured for uplink data compression operation; and in response to the indication, at least one of: performing, locally, a packet data convergence protocol entity re-establishment procedure associated with the at least one data radio bearer, or informing the user equipment to perform a packet data convergence protocol entity re-establishment procedure associated with the at least one data radio bearer.

In accordance with one aspect, an apparatus comprising means for performing: transmitting, to a user equipment, an uplink data compression configuration, wherein the uplink data compression configuration configures one or more data radio bearers to support uplink data compression for the user equipment without initial uplink data compression operation activation; receiving, from the user equipment, an indication to activate at least one data radio bearer of the one or more data radio bearers with uplink data compression configured for uplink data compression operation; and in response to the indication, at least one of: performing, locally, a packet data convergence protocol entity re-establishment procedure associated with the at least one data radio bearer, or informing the user equipment to perform a packet data convergence protocol entity re-establishment procedure associated with the at least one data radio bearer.

In accordance with one aspect, a non-transitory computer-readable medium comprising program instructions stored thereon which, when executed with at least one processor, cause the at least one processor to: transmit, to a user equipment, an uplink data compression configuration, wherein the uplink data compression configuration configures one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

In accordance with one aspect, an apparatus comprising: at least one processor; and at least one memory including computer program code; the at least one memory and the computer program code configured to, with the at least one processor, cause the apparatus at least to: receive, from a network, an uplink data compression configuration, wherein the uplink data compression configuration configures one or more data radio bearers to support uplink data compression at the apparatus without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one aspect, a method comprising: receiving, from an a network, uplink data compression configuration, wherein the uplink data compression configuration configures one or more data radio bearers to support uplink data compression at a user equipment without initial uplink data compression operation activation; transmitting, to the network, an indication to activate at least one data radio bearer of the one or more data radio bearers with uplink data compression configured for uplink data compression operation; and performing a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one aspect, an apparatus comprising means for performing: receiving, from a network, an uplink data compression configuration, wherein the uplink data compression configuration configures one or more data radio bearers to support uplink data compression at the apparatus without initial uplink data compression operation activation; transmitting, to the network, an indication to activate at least one data radio bearer of the one or more data radio bearers with uplink data compression configured for uplink data compression operation; and performing a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one aspect, a non-transitory computer-readable medium comprising program instructions stored thereon which, when executed with at least one processor, cause the at least one processor to: receive, from a network, an uplink data compression configuration, wherein the uplink data compression configuration configures one or more data radio bearers to support uplink data compression at a user equipment without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a diagram illustrating features as described herein;

FIG. 5 is a diagram illustrating features as described herein;

FIG. 6 is a diagram illustrating features as described herein;

FIG. 7 is a flowchart illustrating steps as described herein; and

FIG. 8 is a flowchart illustrating steps as described herein.

### DETAILED DESCRIPTION OF EMBODIMENTS

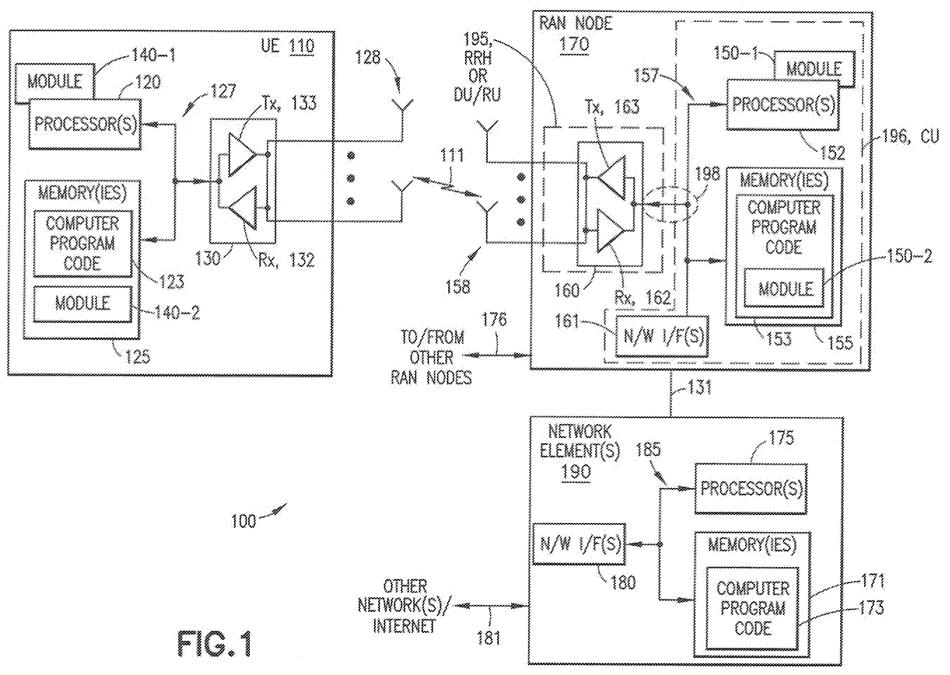

The following abbreviations that may be found in the specification and/or the drawing figures are defined as follows:
3GPP third generation partnership project
5G fifth generation
5GC 5G core network
AMF access and mobility management function
CA carrier aggregation
CE control element
CU central unit
DC dual connectivity
DCI downlink control information
DRB data radio bearer
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FTP file transfer protocol
gNB (or gNodeB) base station for 5G/NR, i.e., a node providing NR user plane and control plane protocol terminations towards the UE, and connected via the NG interface to the 5GC
GSM global system for mobile communications
I/F interface
IE information element
L1 layer 1
LAN local area network
LTE long term evolution
MAC medium access control
MAC-I MAC for data integrity
MME mobility management entity
MR-DC multi-RAT dual communication
ng or NG new generation
ng-eNB or NG-eNB new generation eNB
NR new radio
N/W or NW network
PDCP packet data convergence protocol
PDU protocol data unit
PH PDCP header
PHY physical layer
PUSCH physical uplink shared channel
RAN radio access network
RAT radio access technology
RF radio frequency
RLC radio link control
RRC radio resource control
RRH remote radio head
RS reference signal
RU radio unit
Rx receiver
SA standalone
SDAP service data adaptation protocol
SGW serving gateway
SH SDAP header
SI study item
SMF session management function
SN sequence number
TC5 wireless communication technical committee
TR technical report
Tx transmitter
UDC uplink data compression
UE user equipment (e.g., a wireless, typically mobile device)
UH UDC header
UP user plane
UPF user plane function
VOLTE voice over LTE
WG work group
WI work item
Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), qNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Features as described herein generally relate to uplink data compression (UDC). 3GPP RAN #91e (2021 March) approved Rel-17 WI (RP-210909) for 5G UDC, the objective of which is to specify NR UDC as follows:
“ . . . . Taking LTE UDC mechanism as baseline where appropriate:
   Support UDC for NR SA scenario:
      the signaling and procedures enabling operator control of the DEFLATE-based solution;
      the PDCP PDU format and PDCP procedures supporting UDC solution in NR PDCP;
      pre-defined dictionary (including standard and operator defined), corresponding signaling and procedures . . . ”

In NR UDC discussion, one issue is about a UE's UDC capability indication in NR.

In LTE UDC, a maximum two data radio bearers (DRBs) may be configured in a UDC configuration. The UDC configuration may be one fixed UE's static capability, standardized in TS 36.306.For example, if UDC has been configured to DRB1 for gaming, and to DRB2 for FTP, UDC cannot be configured to DRB3 due to the capability restriction (i.e. maximum 2 DRBs), even if DRB3 is established for VOLTE (i.e. a different service).

In NR, there is support for more service types and number of DRBs than in LTE; accordingly, UDC may benefit uplink data transmission efficiency and save network capacity. Accordingly, the NR system may need a greater number of DRBs supporting UDC than LTE allows (e.g. 2 DRBs). In has been proposed in the drafted CCSA NR UDC TR to increase the maximum number of DRBs supporting UDC to N in NR. N may be more than 2; the value of N is not yet defined. Here, N may be the maximum number of DRBs with UDC configuration that the NR system can configure to one UE.

In LTE UDC, the UDC configuration (pre-defined dictionary, buffer size and others) is configured by the eNB to the UE. However, it may be noted that UDC works for uplink data compression, with data generated in the UE, which may be more aware of the UDC configuration currently needed by the UE. A network configured buffer size may not be suitable; too large may lead to the resource waste, while too small may affect the compression performance.

However, it may be noted that increasing the number of DRBs supporting UDC may not be a good/acceptable solution because it may not be possible to define one value of N acceptable for both the UE(s) and the network. Moreover, having one static value may be considered as lacking in flexibility, regardless of the value of the static value.

In LTE UDC mechanism, after UDC configuration configured, any configured DRB shall apply UDC operation in the uplink at all/any time. Sometimes, the DRB's uplink transmission may be inactive due to service character (e.g. a gaming service has long online time, but discontinuous uplink data transmission). Even still, the UDC is still enabled to the DRB.

It may also be noted that when the number of configured DRBs reaches N, if there are other DRB(s) with active uplink transmission more suitable to apply UDC, it may be impossible to configure UDC to the more suitable DRB(s), unless a DRB already configured with UDC is released. Currently, LTE uses RRCConnectionReconfiguration handover procedure, or drb release and (re) add procedure, to reconfigure UDC to another DRB(s). The network may have to release UDC configuration of the DRB(s) while there is not active uplink transmission, and may turn to configure UDC to other DRB(s) with active uplink transmission.

A proposed solution to NR UDC is to define a larger number of DRB supporting UDC in NR and let the UE report a preferred UDC configuration (e.g., the preferred maximum number of DRBs supporting the UDC configuration, the preferred size of the UDC buffer size, the preferred dictionary, etc.) to a gNB (or other base station/network module). However, the solution doesn't solve the discussed issue; a static UDC configuration mechanism might not be capable of achieving quick DRB switching to use UDC in one UE.

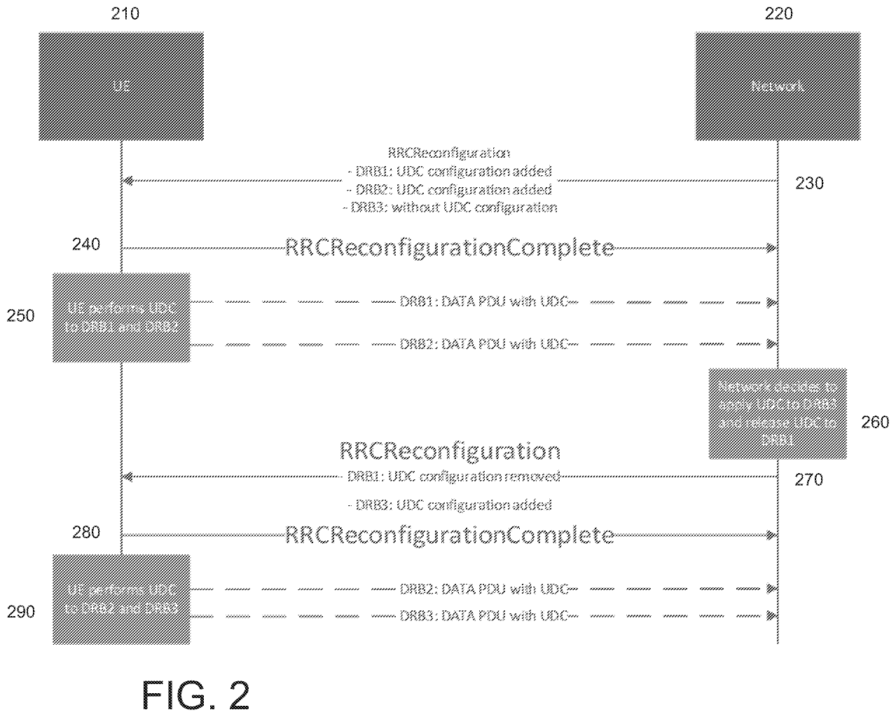

In the non-limiting signaling flow example of FIG. 2, two DRBs supporting NR UDC may be assumed; DRB1 and DRB2 may have been configured to UDC configuration. Network (220), which may be a gNB, base station, or other network module/entity, may transmit an RRCReconfiguration message (230) to the UE (210). The RRCReconfiguration message (230) may cause UDC configuration for DRB1; UDC configuration for DRB2; and no UDC configuration for DRB3. The UE (210) may transmit an RRCReconfigurationComplete message (240) to the network (220). The UE (210) may perform uplink transmission with UDC via DRB1 and DRB2 (250). In other words, the UE (210) may transmit, to the network (220), a DATA PDU with UDC via DRB1, and a DATA PDU with UDC via DRB2. If the network (220) wants to configure UDC to DRB3, which may be more suitable for UDC configuration, the network (220) may, for example, decide to release UDC configuration of DRB1, and to configure UDC configuration to DRB3 (260). The network (220) may transmit an RRCReconfiguration message (270) to the UE (210). The RRCReconfiguration message (270) may cause UDC configuration of DRB1 to be removed, and UDC configuration of DRB3 to be added. The UE (210) may transmit an RRCReconfigurationComplete message (280) to the network (220). The UE (210) may perform uplink transmission with UDC via DRB2 and DRB3 (290). In other words, the UE (210) may transmit, to the network (220), a DATA PDU with UDC via DRB2, and a DATA PDU with UDC via DRB3.

Such a UDC mechanism in LTE and NR, as illustrated in FIG. 2, may be considered to lack flexibility and timely DRB switching to apply UDC to more suitable DRBs, according to UE's uplink data transmission variation and UE preference(s).

Example embodiments of the present disclosure may have the technical effect of achieving UE flexible selection of DRBs to apply UDC.

Example embodiments of the present disclosure may have the technical effect of allowing rapid DRB switching to apply UDC.

In example embodiments of the present disclosure, the number (N) of DRB supporting UDC may be defined by NR UDC.

In an example embodiment, for a single UE, the network may configure a UDC configuration to every DRB that is suitable for use with UDC. However, the configured UDC may not be enabled for uplink data transmission after configuration. In other words, the configuration of the DRBs for UDC may not be initially activated (i.e. the DRBs may not be enabled to perform uplink transmission with UDC). In other words, the UDC configurations of the configured DRBs may be inactive. Additionally or alternatively, the configured DRBs may be in a UDC inactive state that can be switched to a UDC active state by the network. The number of DRBs that may be configured by the network for UDC may not be restricted by N.

In an example embodiment, at any time, a UE may select up to N DRBs from all the DRBs with UDC configuration, and may indicate to the network these selected DRBs, so that the network may activate the respective UDC configuration(s) of these selected DRBs. The number of DRBs for which the UDC configuration is activated for a specific UE may be less than or equal to N.

In an example embodiment, the UE may indicate to the network which DRB(s) is selected for UDC activation according to one or more alternative ways. The DRB ID or other existing/future ID that can identify a DRB may be used as (or as part of) an indication. In an example embodiment, the UE indication to the network may be added in an RRC uplink message, with a new IE of List of DRB IDs. In another example embodiment, the UE indication to the network may be added in a PUSCH MAC CE or PDCP/SDAP control frame, with a field of List of DRB IDs. In another example embodiment, the UE indication to the network may be added in a PDCP/SDAP Head of Data PDU of each selected DRB, with one bit flag.

In an example embodiment, when the network receives the UE indication, the network may trigger PDCP entity re-establishment to the UE for the UE selected DRBS by an RRCReconfiguration procedure; both the network and the UE may activate UDC for the selected DRBs after the PDCP entity re-establishment procedure has been performed.

In another example embodiment, the UE may perform PDCP entity re-establishment locally after transmitting the indication to the network. In other words, the UE may not wait for the network to initiate an RRCReconfiguration procedure to perform PDCP entity re-establishment. In another example embodiment, the network may perform the PDCP entity re-establishment locally when the indication is received. In other words, the network may perform the PDCP entity re-establishment before (or without) initiating an RRCReconfiguration procedure. In another example embodiment, after transmitting the indication to the network, the UE may perform PDCP entity re-establishment locally when a dedicated timer expires. The timer may begin upon transmission of the indication. In another example embodiment, after the indication has been received in the network, the network may perform PDCP entity re-establishment locally when a dedicated timer expires. The timer may begin upon receipt of the indication. Example embodiments of the present disclosure may have the technical effect of saving the network initiated PDCP entity re-establishment by one RRCReconfiguration procedure.

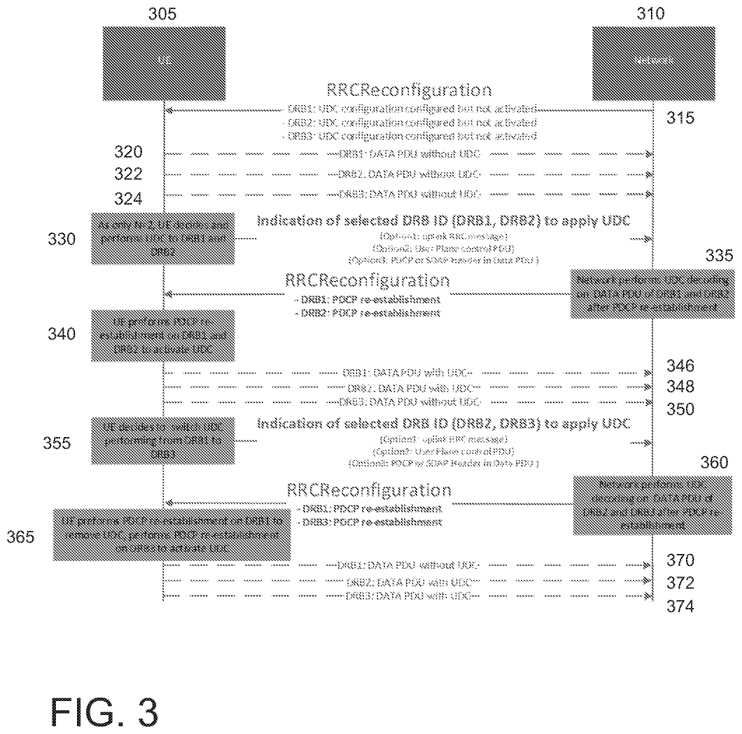

Referring now to FIG. 3, illustrated is an example of signaling flow according to an example embodiment of the present disclosure. In the example of FIG. 3, N=2 for UE (305). In other words, only two DRBs of one UE (305) may have UDC activation in uplink data transmission. The network (310) may send/transmit an RRCReconfiguration message (315) to the UE (305) to configure a UDC configuration to each DRB1, DRB2, and DRB3 of the UE (305). The RRCReconfiguration message (315) may cause DRB1, DRB2, and DRB3 to be configured for UDC, but not have UDC activated for uplink transmission. After receiving the RRCReconfiguration message (315), uplink DATA PDUs of DRB1 (320), DRB2 (322), and DRB3 (323) may be transmitted normally, i.e. without UDC activation. The UE (305) may decide, and inform the network (310), that DRB1 and DRB2 are selected to activate UDC (330). In an example embodiment, the indication of the selected DRB ID (e.g. DRB1, DRB2) to apply/activate UDC may be transmitted to the network (310) via an uplink RRC message. In another example embodiment, the indication of the selected DRB ID (e.g. DRB1, DRB2) to apply/activate UDC may be transmitted to the network (310) via a user plane control PDU. In another example embodiment, the indication of the selected DRB ID (e.g. DRB1, DRB2) to apply/activate UDC may be transmitted to the network (310) via a PDCP or SDAP header in a data PDU.

The network (310) may send a RRCReconfiguration message (335) with reestablishPDCP=True and with optional new IE activateUDC=True of DRB1 and DRB2. The new IE activateUDC may indicate to the UE (305) that PDCP reestablishment is to be performed for UDC activation. Both the UE (305) and the network (310) may perform PDCP entity re-establishment of DRB1 and DRB2(335, 340). After the PDCP entity re-establishment procedure, uplink DATA PDUs of DRB1 and DRB2 may be switched to UDC activated (346, 348); uplink DATA PDUs of DRB3 may be kept as normal (350) (i.e. transmitted normally). It may be noted that the RRCReconfiguration message (335) may be optional; in another example embodiment, UDC operation activation and/or PDCP entity re-establishment procedures may be performed by UE (305) and/or network (310) without the use of the RRCReconfiguration message (335).

The UE (305) may decide, and may inform the network (310), that DRB2 and DRB3 are selected to activate UDC (355). In an example embodiment, the indication of the selected DRB ID (e.g. DRB2, DRB3) to apply/activate UDC may be transmitted to the network (310) via an uplink RRC message. In another example embodiment, the indication of the selected DRB ID (e.g. DRB2, DRB3) to apply/activate UDC may be transmitted to the network (310) via a user plane control PDU. In another example embodiment, the indication of the selected DRB ID (e.g. DRB3) DRB2, to apply/activate UDC may be transmitted to the network (310) via a PDCP or SDAP header in a data PDU.

In step 355, DRB2 has already been activated for UDC, and does not need to switch; only DRB1 and DRB3 need switching (between UDC activated and not activated) in uplink. The network (310) may send a RRCReconfiguration message (360) with reestablishPDCP=True and with optional new IE activateUDC=True of DRB1 and DRB3. After PDCP has been reestablished, uplink DATA PDUs of DRB1 may be switched to normal without UDC activation (370); uplink DATA PDUS of DRB2 may be kept as UDC activated (372); uplink DATA PDUs of DRB3 may be switched to UDC activated (374).

It may be noted that the example of FIG. 3 is not limiting; the value of N may be different, the number of DRBs configured for UDC may be different, the DRBs selected for UDC activation or deactivation may be different, etc.

In an example embodiment, for example at step 330 and/or 355 of FIG. 3, there may be alternative options for indication of a selected DRB ID to apply UDC (i.e. activate UDC configuration). In an example embodiment, a selected DRB ID list may be added in an uplink RRC message, for example RRCReconfigurationComplete, UEAssistanceInformation, etc. A technical effect of this example embodiment may be that a reliable and/or flexible indication may be designated by a RRC message, not only for selected DRB IDs, but also for non-selected DRB IDs.

In another example embodiment, a selected DRB ID list may be added in a user plane uplink control PDU, for example a SDAP/PDCP control PDU, MAC CE, etc. A technical effect of this example embodiment may be provision of a quicker indication than RRC signaling. It may be noted that this example embodiment may require definition of a new control PDU format.

In an example embodiment, a base station (e.g. gNB) may send a UDC configuration to UE by RRCReconfiguration message, without UDC operation activation. The gNB may receive an indication from the UE. The indication may include one or more DRB IDs. The indication may indicate one or more DRBs to activate UDC operation. In other words, the indication may be configured to cause the gNB to activate UDC operation for the one or more indicated DRBs, and/or inform the gNB that the one or more indicated DRBs will be re-established locally at the UE. In response to the indication, the gNB may perform a PDCP entity re-establishment procedure. For example, the gNB may perform a PDCP re-establish procedure locally, with no further RRC (or other) message sent to the UE. In this example embodiment, a timer may be applied at the gNB and at the UE for UDC operation activation.

In another example embodiment, a base station (e.g. gNB) may send a UDC configuration to a UE by a RRCReconfiguration message, without UDC operation activation. The gNB may receive an indication from the UE. The indication may include one or more DRB IDs. The indication may comprise a UE request to activate one or more DRBs for UDC operation. In other words, the UE may indicate that the indicated DRBs will not be activated for UDC operation until a command is received from the gNB, and may request that the gNB also activate the indicated DRBs for UDC operation. In response to the indication, the gNB may transmit a PDCP entity re-establishment command to the UE by a RRCReconfiguration message, and also activate UDC operation locally. Alternatively, the PDCP entity re-establishment command may be transmitted via a MAC CE or a downlink control information (DCI) message. In this example embodiment, the gNB may use a (new) flag to indicate that the PDCP entity re-establishment command is only UDC operation activation, so as to distinguish from other normal PDCP entity re-establishment command(s) in RRC message(s).

In an example embodiment, a UE may receive a UDC configuration from a gNB via RRC message, without UDC operation activation. The UE may send an indication to the gNB to indicate for which DRBs to activate UDC operation. In other words, the indication may be configured to cause the gNB to activate UDC operation for the one or more indicated DRBs, and/or inform the gNB that the PDCP entity of one or more indicated DRBs will be re-established locally at the UE. The UE may perform/trigger a PDCP entity re-establishment procedure directly or after one timer expired, after sent out (i.e. indication in response to transmitting the indication). In other words, transmitting the indication may serve as a trigger for the UE to perform the PDCP entity re-establishment procedure or start one timer and perform the PDCP entity re-establishment after the timer expired.

In an example embodiment, a UE may receive a UDC configuration from a gNB via RRC message, without UDC operation activation. The UE may send an indication to the gNB to request activation of one or more DRVs for UDC operation. In other words, the UE may indicate that the indicated DRBs will not be activated for UDC operation until a command is received from the gNB, and may request that the gNB also activate the indicated DRBs for UDC operation. The UE may perform/trigger a re-PDCP entity establishment procedure only after a PDCP entity re-establishment command is received from the gNB. The PDCP entity re-establishment command may be received via an RRCReconfiguration message, a MAC CE, or DCI.

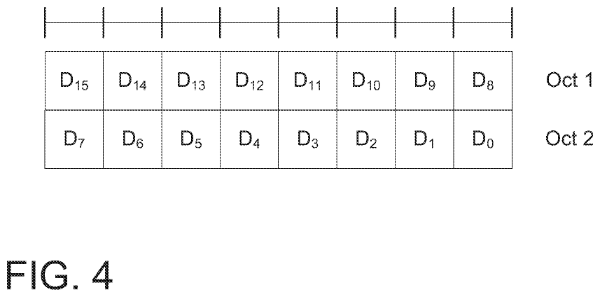

Referring now to FIG. 4 illustrated is a UDC enable/disable preference indication included in a MAC CE. The MAC CE may, in a non-limiting example, include a first octet (Oct1) and a second octet (Oct2). Each octet may include eight DRB-specific fields. The associated DRBs of each fields are indicated in FIG. 4 by Dᵢ. The Dᵢ field may indicate the UDC enable/disable preference (of the selecting UE) of DRB i, where i may be the order of the DRB ID among the DRBs configured to the UE. The Dᵢ field may be set to 1 to indicate that the UDC is preferred to be enabled for DRB i. The Dᵢ field may be set to 0 to indicate that the UDC is preferred to be disabled for DRB i. This example is non-limiting; other values may be used to indicate which DRBs are to have the UDC configuration activated and/or deactivated.

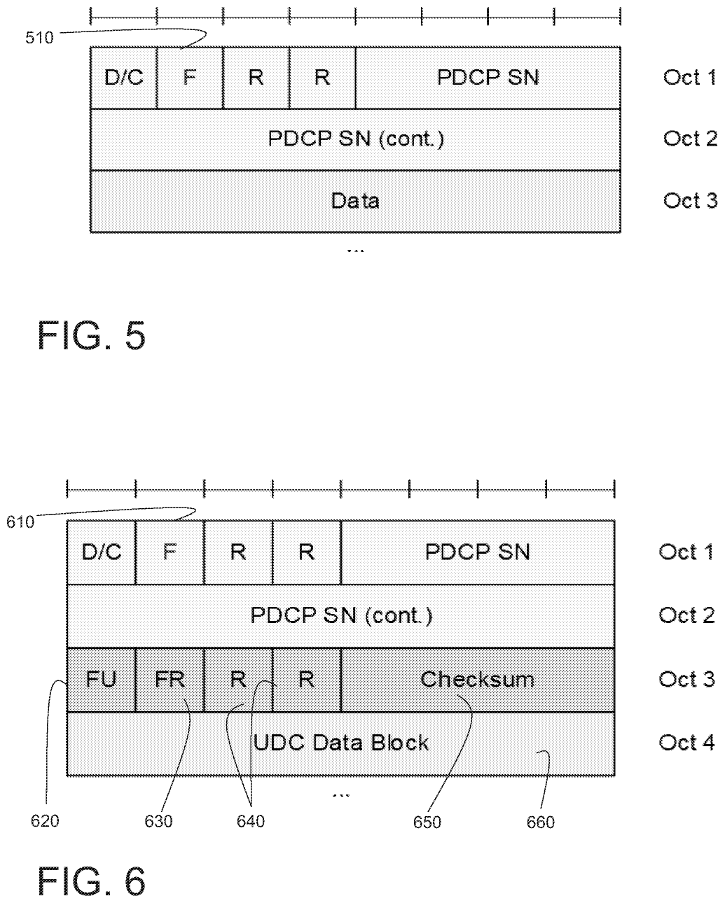

In another example embodiment, a new field may be added in a SDAP Header or PDCP Header of a DATA PDU for one particular DRB. A technical effect of this example embodiment may be provision of a quicker indication than RRC signaling. It may be noted that this example embodiment may require a small change to specification. It may also be noted that this example embodiment might only allow for switching a DRB (i.e. between UDC active and inactive state) one by one, which may have the technical effect of triggering several RRCReconfiguration messages for PDCP entity re-establishment. For example, a one bit flag (i.e. field “F” (510) of FIG. 5) may be added in the PDCP header to indicate the DRB preferred for enablement/disablement of UDC, where flag=1 may indicate that UDC is preferred to be enabled, and where flag=0 may indicate that UDC is preferred to be disabled/not enabled. This example is non-limiting; other values may be used to indicate which DRBs are to have the UDC configuration activated and/or deactivated.

FIG. 5 illustrates a non-limiting example of a PDCP data PDU format for DRBs using a 12 bit sequence number (SN). In the example of FIG. 5, UDC may not be configured. The PDU format may include three octets (e.g. Oct1, Oct2, and Oct3). Oct1 may include D/C, F (510), R, and PDCP SN fields. Oct2 may include a continuation of the PDCP SN field. Oct3 may include a data field.

Referring now to FIG. 6, illustrated is a non-limiting example of a PDCP data PDU format for DRBs using a 12 bit SN. In the example of FIG. 6, UDC may be configured. The PDU format may include four octets (e.g. Oct1, Oct2, Oct3, and Oct4). Oct1 may include D/C, F (610), R, and PDCP SN fields. Oct2 may include a continuation of the PDCP SN field. Oct3 may include FU (620), FR (630), R (640), and checksum (650) fields. Oct4 may include a UDC data block (660).

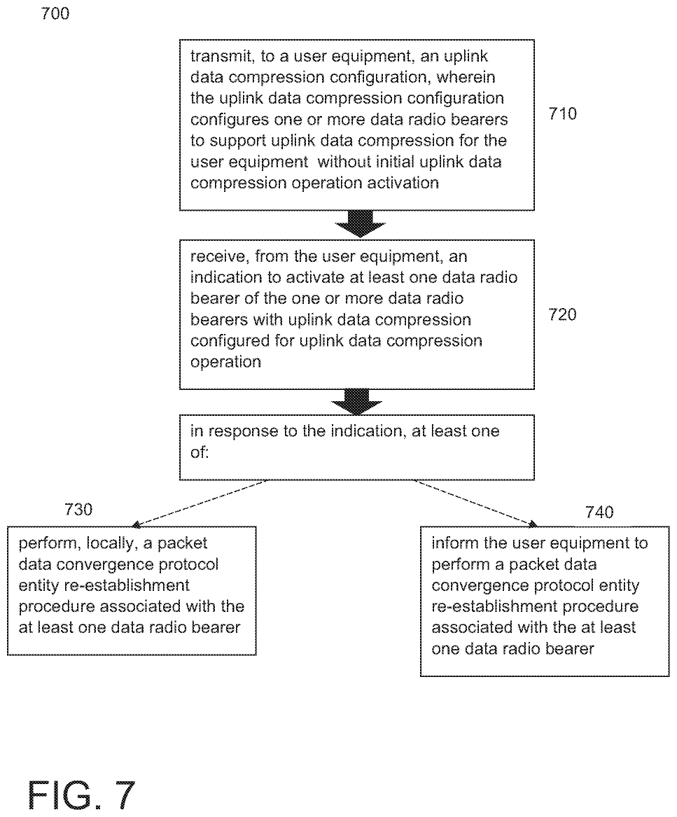

FIG. 7 illustrates the potential steps of an example method 700. The example method 700 may include: transmitting, to a user equipment, an uplink data compression configuration, wherein the uplink data compression configuration configures one or more data radio bearers to support uplink data compression for the user equipment without initial uplink data compression operation activation, 710; receiving, from the user equipment, an indication to activate at least one data radio bearer of the one or more data radio bearers with uplink data compression configured for uplink data compression operation, 720; and in response to the indication, at least one of: performing, locally, a packet data convergence protocol entity re-establishment procedure associated with the at least one data radio bearer, 730; or informing the user equipment to perform a packet data convergence protocol entity re-establishment procedure associated with the at least one data radio bearer, 740. The indication may comprise a request to activate the at least one data radio bearer.

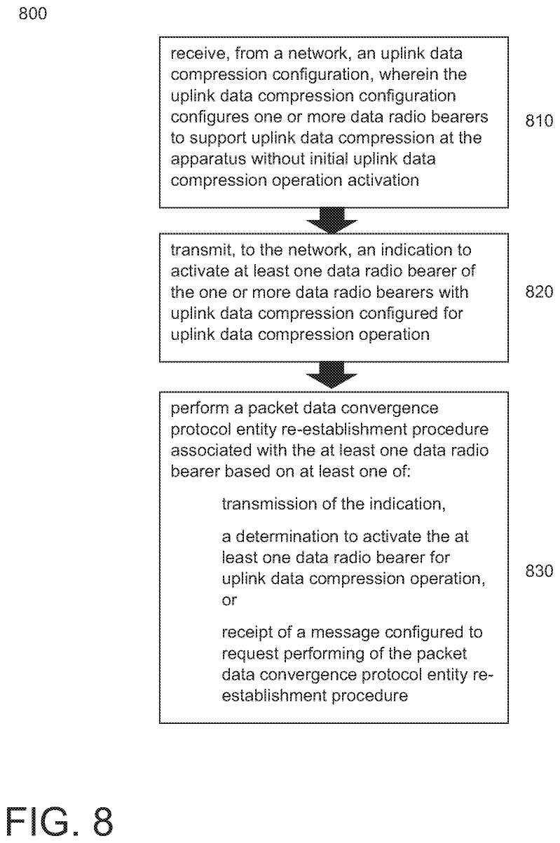

FIG. 8 illustrates the potential steps of an example method 800. The example method 800 may include: receiving, from a network, an uplink data compression configuration, wherein the uplink data compression configuration configures one or more data radio bearers to support uplink data compression at the apparatus without initial uplink data compression operation activation, 810; transmitting, to the network, an indication to activate at least one data radio bearer of the one or more data radio bearers with uplink data compression configured for uplink data compression operation, 820; and performing a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure, 830. The indication may comprise a request to activate the at least one data radio bearer. In an example embodiment, the PDCP entity re-establishment procedure associated with the at least one data radio bearer may be performed because a UE has determined to activate and/or transmit an indication to activate the least one data radio bearer of the one or more data radio bearers with uplink data compression configured for uplink data compression operation. In other words, the PDCP entity re-establishment procedure may be performed in response to a determination made by the UE; the indication may be transmitted in response to the determination as well.

In accordance with one example embodiment, an apparatus may comprise: at least one processor; and at least one memory including computer program code; the at least one memory and the computer program code configured to, with the at least one processor, cause the apparatus at least to: transmit, to a user equipment, an uplink data compression configuration, wherein the uplink data compression configuration may configure one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

The uplink data compression configuration may comprise at least one of: a predefined dictionary for uplink data compression, or a buffer size for uplink data compression.

The example apparatus may be further configured to: inform the user equipment to perform the packet data convergence protocol entity re-establishment procedure for the at least one data radio bearer, which may comprise causing the example apparatus to: transmit a message to the user equipment, wherein the message may comprise an information element configured to indicate uplink data compression operation activation for the at least one data radio bearer, wherein the message may comprise at least one of: a radio resource control reconfiguration message, a medium access control control element, or downlink control information.

The example apparatus may be further configured to: activate the at least one data radio bearer for uplink data compression operation.

Activating the at least one data radio bearer for uplink data compression operation may comprise the example apparatus being further configured to: deactivate a data radio bearer for uplink data compression operation according to the indication received from the user equipment.

The radio resource control reconfiguration message may comprise a flag configured to indicate that the packet data convergence protocol entity re-establishment procedure is for uplink data compression operation activation (only).

The example apparatus may be further configured to: perform, locally, the packet data convergence protocol entity re-establishment procedure associated with the at least one data radio bearer in response to at least one of: a time of receipt of the indication, or expiration of a timer.

The example apparatus may be further configured to: receive, from the user equipment, a data protocol data unit using uplink data compression via one or more of the at least one data radio bearers with activated uplink data compression operation.

The indication may comprise at least one of: an uplink radio resource control message, an indication of a data radio bearer identifier for respective ones of the at least one data radio bearer, an information element of the uplink radio resource control message, wherein the information element may comprise a list of data radio bearer identifiers for the at least one data radio bearer, a field of a physical uplink shared channel medium access control control element, wherein the field may comprise the list of data radio bearer identifiers for the at least one data radio bearer, a field of a packet data convergence protocol or service data adaptation protocol control frame, wherein the field may comprise the list of data radio bearer identifiers for the at least one data radio bearer, a flag of a packet data convergence protocol or service data adaptation protocol head of data physical data unit for the respective ones of the at least one data radio bearer, wherein the flag may be configured to indicate whether uplink data compression operation for the respective ones of the at least one data radio bearer are to be activated or deactivated, or a user plane control physical data unit.

The example apparatus may be further configured to: receive uplink data from the user equipment via a data radio bearer of the one or more data radio bearers without uplink data compression.

In accordance with one aspect, an example method may be provided comprising: transmitting, to a user equipment, an uplink data compression configuration, wherein the uplink data compression configuration may configure one or more data radio bearers to support uplink data compression for the user equipment without initial uplink data compression operation activation; receiving, from the user equipment, an indication to activate at least one data radio bearer of the one or more data radio bearers with uplink data compression configured for uplink data compression operation; and in response to the indication, at least one of: performing, locally, a packet data convergence protocol entity re-establishment procedure associated with the at least one data radio bearer, or informing the user equipment to perform a packet data convergence protocol entity re-establishment procedure associated with the at least one data radio bearer.

The uplink data compression configuration may comprise at least one of: a predefined dictionary for uplink data compression, or a buffer size for uplink data compression.

The example method may further comprise: informing the user equipment to perform the packet data convergence protocol entity re-establishment procedure for the at least one data radio bearer, further comprising: transmitting a message to the user equipment, wherein the message may comprise an information element configured to indicate uplink data compression operation activation for the at least one data radio bearer, wherein the message may comprise at least one of: a radio resource control reconfiguration message, a medium access control control element, or downlink control information.

The example method may further comprise: activating the at least one data radio bearer for uplink data compression operation.

The activating of the at least one data radio bearer for uplink data compression operation may comprise: deactivating a data radio bearer for uplink data compression operation according to the indication received from the user equipment.

The radio resource control reconfiguration message may comprise a flag configured to indicate that the packet data convergence protocol entity re-establishment procedure is for uplink data compression operation activation (only).

The example method may further comprise: performing, locally, the packet data convergence protocol entity re-establishment procedure associated with the at least one data radio bearer in response to at least one of: a time of receipt of the indication, or expiration of a timer.

The example method may further comprise: receiving, from the user equipment, a data protocol data unit using uplink data compression via one or more of the at least one data radio bearers with activated uplink data compression operation.

The indication may comprise at least one of: an uplink radio resource control message, an indication of a data radio bearer identifier for respective ones of the at least one data radio bearer, an information element of the uplink radio resource control message, wherein the information element may comprise a list of data radio bearer identifiers for the at least one data radio bearer, a field of a physical uplink shared channel medium access control control element, wherein the field may comprise the list of data radio bearer identifiers for the at least one data radio bearer, a field of a packet data convergence protocol or service data adaptation protocol control frame, wherein the field may comprise the list of data radio bearer identifiers for the at least one data radio bearer, a flag of a packet data convergence protocol or service data adaptation protocol head of data physical data unit for the respective ones of the at least one data radio bearer, wherein the flag may be configured to indicate whether uplink data compression operation for the respective ones of the at least one data radio bearer are to be activated or deactivated, or a user plane control physical data unit.

The example method may further comprise: receiving uplink data from the user equipment via a data radio bearer of the one or more data radio bearers without uplink data compression.

In accordance with one example embodiment, an apparatus may comprise: circuitry configured to perform: transmit, to a user equipment, an uplink data compression configuration, wherein the uplink data compression configuration may configure one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

In accordance with one example embodiment, an apparatus may comprise: processing circuitry; memory circuitry including computer program code, the memory circuitry and the computer program code configured to, with the processing circuitry, enable the apparatus to: transmit, to a user equipment, an uplink data compression configuration, wherein the uplink data compression configuration may configure one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: transmitting, to a user equipment, an uplink data compression configuration, wherein the uplink data compression configuration may configure one or more data radio bearers to support uplink data compression for the user equipment without initial uplink data compression operation activation; receiving, from the user equipment, an indication to activate at least one data radio bearer of the one or more data radio bearers with uplink data compression configured for uplink data compression operation; and in response to the indication, at least one of: performing, locally, a packet data convergence protocol entity re-establishment procedure associated with the at least one data radio bearer, or informing the user equipment to perform a packet data convergence protocol entity re-establishment procedure associated with the at least one data radio bearer.

In accordance with one example embodiment, a non-transitory computer-readable medium comprising program instructions stored thereon which, when executed with at least one processor, cause the at least one processor to: transmit, to a user equipment, an uplink data compression configuration, wherein the uplink data compression configuration may configure one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

In accordance with another example embodiment, a non-transitory program storage device readable by a machine may be provided, tangibly embodying a program of instructions executable by the machine for performing operations, the operations comprising: transmit, to a user equipment, an uplink data compression configuration, wherein the uplink data compression configuration may configure one or more data radio bearers to support uplink data compression for the user equipment without initial uplink data compression operation activation; receive, from the user equipment, an indication to activate at least one data radio bearer of the one or more data radio bearers with uplink data compression configured for uplink data compression operation; and in response to the indication, at least one of: perform, locally, a packet data convergence protocol entity re-establishment procedure associated with the at least one data radio bearer, or inform the user equipment to perform a packet data convergence protocol entity re-establishment procedure associated with the at least one data radio bearer.

In accordance with one example embodiment, an apparatus may comprise: at least one processor; and at least one memory including computer program code; the at least one memory and the computer program code configured to, with the at least one processor, cause the apparatus at least to: receive, from a network, an uplink data compression configuration, wherein the uplink data compression configuration may configure one or more data radio bearers to support uplink data compression at the apparatus without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

The uplink data compression configuration may comprise at least one of: a predefined dictionary for uplink data compression, or a buffer size for uplink data compression.

The transmitted indication may be configured to request the network to activate the at least one data radio bearer for uplink data compression operation, wherein the example apparatus may be further configured to: perform the packet data convergence protocol entity re-establishment procedure for the at least one data radio bearer based on the received message, wherein the message configured to request performing of the packet data convergence protocol entity re-establishment procedure may comprise an information element indicating uplink data compression operation activation for the at least one data radio bearer, wherein the message may comprise at least one of: a radio resource control reconfiguration message, a medium access control control element, or downlink control information.

The example apparatus may be further configured to: transmit, to the network, a data protocol data unit using uplink data compression via one or more of the at least one data radio bearers with activated uplink data compression operation.

The example apparatus may be further configured to: deactivate a data radio bearer for uplink data compression operation, wherein a total number of data radio bearers with activated uplink data compression operation may be less than or equal to a specified maximum number of data radio bearers configured to support uplink data compression for the apparatus.

The radio resource control reconfiguration message may comprise a flag configured to indicate that the packet data convergence protocol entity re-establishment procedure is for uplink data compression operation activation (only).

The transmitted indication may be configured to request the network to perform a packet data convergence protocol entity re-establishment procedure associated with the at least one data radio bearer, wherein the packet data convergence protocol entity re-establishment procedure may be performed based on the transmission of the indication and further in response to at least one of: a time of transmission of the indication, or expiration of a timer.

The indication may comprise at least one of: an uplink radio resource control message, an indication of a data radio bearer identifier for respective ones of the at least one data radio bearer, an information element of the uplink radio resource control message, wherein the information element may comprise a list of data radio bearer identifiers for the at least one data radio bearer, a field of a physical uplink shared channel medium access control control element, wherein the field may comprise the list of data radio bearer identifiers for the at least one data radio bearer, a field of a packet data convergence protocol or service data adaptation protocol control frame, wherein the field may comprise the list of data radio bearer identifiers for the at least one data radio bearer, a flag of a packet data convergence protocol or service data adaptation protocol head of data physical data unit for the respective ones of the at least one data radio bearer, wherein the flag may be configured to indicate whether uplink data compression operation for the respective ones of the at least one data radio bearer are to be activated or deactivated, or a user plane control physical data unit.

The example apparatus may be further configured to: transmit uplink data via a data radio bearer of the one or more data radio bearers without uplink data compression.

A number of the at least one data radio bearer may comprise less than or equal to a specified maximum number of data radio bearers configured to support uplink data compression for the apparatus.

In accordance with one aspect, an example method may be provided comprising: receiving, from a network, an uplink data compression configuration, wherein the uplink data compression configuration may configure one or more data radio bearers to support uplink data compression at a user equipment without initial uplink data compression operation activation; transmitting, to the network, an indication to activate at least one data radio bearer of the one or more data radio bearers with uplink data compression configured for uplink data compression operation; and performing a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

The uplink data compression configuration may comprise at least one of: a predefined dictionary for uplink data compression, or a buffer size for uplink data compression.

The transmitted indication may be configured to request the network to activate the at least one data radio bearer for uplink data compression operation, wherein the example method may further comprise: performing the packet data convergence protocol entity re-establishment procedure for the at least one data radio bearer based on the received message, wherein the message configured to request performing of the packet data convergence protocol entity re-establishment procedure may comprise an information element indicating uplink data compression operation activation for the at least one data radio bearer, wherein the message may comprise at least one of: a radio resource control reconfiguration message, a medium access control control element, or downlink control information.

The example method may further comprise: transmitting, to the network, a data protocol data unit using uplink data compression via one or more of the at least one data radio bearers with activated uplink data compression operation.

The example method may further comprise: deactivating a data radio bearer for uplink data compression operation, wherein a total number of data radio bearers with activated uplink data compression operation may be less than or equal to a specified maximum number of data radio bearers configured to support uplink data compression for the user equipment.

The radio resource control reconfiguration message may comprise a flag configured to indicate that the packet data convergence protocol entity re-establishment procedure is for uplink data compression operation activation (only).

The transmitted indication may be configured to request the network to perform a packet data convergence protocol entity re-establishment procedure associated with the at least one data radio bearer, wherein the packet data convergence protocol entity re-establishment procedure may be performed based on the transmission of the indication and further in response to at least one of: a time of transmission of the indication, or expiration of a timer.

The indication may comprise at least one of: an uplink radio resource control message, an indication of a data radio bearer identifier for respective ones of the at least one data radio bearer, an information element of the uplink radio resource control message, wherein the information element may comprise a list of data radio bearer identifiers for the at least one data radio bearer, a field of a physical uplink shared channel medium access control control element, wherein the field may comprise the list of data radio bearer identifiers for the at least one data radio bearer, a field of a packet data convergence protocol or service data adaptation protocol control frame, wherein the field may comprise the list of data radio bearer identifiers for the at least one data radio bearer, a flag of a packet data convergence protocol or service data adaptation protocol head of data physical data unit for the respective ones of the at least one data radio bearer, wherein the flag may be configured to indicate whether uplink data compression operation for the respective ones of the at least one data radio bearer are to be activated or deactivated, or a user plane control physical data unit.

The example method may further comprise: transmitting uplink data via a data radio bearer of the one or more data radio bearers without uplink data compression.

A number of the at least one data radio bearer may comprise less than or equal to a specified maximum number of data radio bearers configured to support uplink data compression for the user equipment.

In accordance with one example embodiment, an apparatus may comprise: circuitry configured to perform: receive, from a network, an uplink data compression configuration, wherein the uplink data compression configuration may configure one or more data radio bearers to support uplink data compression at the apparatus without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one example embodiment, an apparatus may comprise: processing circuitry; memory circuitry including computer program code, the memory circuitry and the computer program code configured to, with the processing circuitry, enable the apparatus to: receive, from a network, an uplink data compression configuration, wherein the uplink data compression configuration may configure one or more data radio bearers to support uplink data compression at the apparatus without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one example embodiment, an apparatus may comprise means for performing: receiving, from a network, an uplink data compression configuration, wherein the uplink data compression configuration may configure one or more data radio bearers to support uplink data compression at the apparatus without initial uplink data compression operation activation; transmitting, to the network, an indication to activate at least one data radio bearer of the one or more data radio bearers with uplink data compression configured for uplink data compression operation; and performing a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with one example embodiment, a non-transitory computer-readable comprising program medium instructions stored thereon which, when executed with at least one processor, cause the at least one processor to: receive, from a network, an uplink data compression configuration, wherein the uplink data compression configuration may configure one or more data radio bearers to support uplink data compression at a user equipment without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

In accordance with another example embodiment, a non-transitory program storage device readable by a machine may be provided, tangibly embodying a program of instructions executable by the machine for performing operations, the operations comprising: receive, from a network, an uplink data compression configuration, wherein the uplink data compression configuration may configure one or more data radio bearers to support uplink data compression at a user equipment without initial uplink data compression operation activation; transmit, to the network, an indication to activate at least one data radio bearer of the one or more data radio bearers with uplink data compression configured for uplink data compression operation; and perform a packet data convergence protocol entity re-establishment procedure associated with the at least one data radio bearer based on at least one of: transmission of the indication, a determination to activate the at least one data radio bearer for uplink data compression operation, or receipt of a message configured to request performing of the packet data convergence protocol entity re-establishment procedure.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-46. (canceled)

47. An apparatus comprising:
at least one processor; and
at least one non-transitory memory including computer program code;
the at least one memory and the computer program code configured to, with the at least one processor, cause the apparatus at least to:
receive, from a network, an uplink data compression configuration, wherein the uplink data compression configuration configures one or more data radio bearers to support uplink data compression at the apparatus without initial uplink data compression operation activation;
transmit, to the network, an indication to activate at least one data radio bearer of the one or more data radio bearers with uplink data compression configured for uplink data compression operation; and
perform a packet data convergence protocol entity re-establishment procedure associated with the at least one data radio bearer based on at least one of:
transmission of the indication,
a determination to activate the at least one data radio bearer for uplink data compression operation, or
receipt of a message configured to request performing of the packet data convergence protocol entity re-establishment procedure.

48. The apparatus of claim 47, wherein the uplink data compression configuration comprises at least one of:
a predefined dictionary for uplink data compression, or
a buffer size for uplink data compression.

49. The apparatus of claim 47, wherein the transmitted indication is configured to request the network to activate the at least one data radio bearer for uplink data compression operation, wherein the at least one memory and the computer program code are configured to, with the at least one processor, cause the apparatus to:
perform the packet data convergence protocol entity re-establishment procedure for the at least one data radio bearer based on the received message, wherein the message configured to request performing of the packet data convergence protocol entity re-establishment procedure comprises an information element indicating uplink data compression operation activation for the at least one data radio bearer, wherein the message comprises at least one of:
a radio resource control reconfiguration message,
a medium access control control element, or
downlink control information.

50. The apparatus of claim 49, wherein the at least one memory and the computer program code are configured to, with the at least one processor, cause the apparatus to:
transmit, to the network, a data protocol data unit using uplink data compression via one or more of the at least one data radio bearers with activated uplink data compression operation.

51. The apparatus of claim 49, wherein the at least one memory and the computer program code are configured to, with the at least one processor, cause the apparatus to:
deactivate a data radio bearer for uplink data compression operation, wherein a total number of data radio bearers with activated uplink data compression operation is less than or equal to a specified maximum number of data radio bearers configured to support uplink data compression for the apparatus.

52. The apparatus of claim 49, wherein the radio resource control reconfiguration message comprises a flag configured to indicate that the packet data convergence protocol entity re-establishment procedure is for uplink data compression operation activation only.

53. The apparatus of claim 47, wherein the transmitted indication is configured to request the network to perform a packet data convergence protocol entity re-establishment procedure associated with the at least one data radio bearer, wherein the packet data convergence protocol entity re-establishment procedure is performed based on the transmission of the indication and further in response to at least one of:
a time of transmission of the indication, or
expiration of a timer.

54. The apparatus of claim 47, wherein the indication comprises at least one of:
an uplink radio resource control message,
an indication of a data radio bearer identifier for respective ones of the at least one data radio bearer,
an information element of the uplink radio resource control message, wherein the information element comprises a list of data radio bearer identifiers for the at least one data radio bearer,
a field of a physical uplink shared channel medium access control control element, wherein the field comprises the list of data radio bearer identifiers for the at least one data radio bearer,
a field of a packet data convergence protocol or service data adaptation protocol control frame,
wherein the field comprises the list of data radio bearer identifiers for the at least one data radio bearer,
a flag of a packet data convergence protocol or service data adaptation protocol head of data physical data unit for the respective ones of the at least one data radio bearer, wherein the flag is configured to indicate whether uplink data compression operation for the respective ones of the at least one data radio bearer are to be activated or deactivated, or
a user plane control physical data unit.

55. The apparatus of claim 47, wherein the at least one memory and the computer program code are configured to, with the at least one processor, cause the apparatus to:
transmit uplink data via a data radio bearer of the one or more data radio bearers without uplink data compression.

56. The apparatus of claim 47, wherein a number of the at least one data radio bearer comprises less than or equal to a specified maximum number of data radio bearers configured to support uplink data compression for the apparatus.

57. A method comprising:
receiving, from a network, an uplink data compression configuration, wherein the uplink data compression configuration configures one or more data radio bearers to support uplink data compression at a user equipment without initial uplink data compression operation activation;
transmitting, to the network, an indication to activate at least one data radio bearer of the one or more data radio bearers with uplink data compression configured for uplink data compression operation; and
performing a packet data convergence protocol entity re-establishment procedure associated with the at least one data radio bearer based on at least one of:
transmission of the indication,
a determination to activate the at least one data radio bearer for uplink data compression operation, or
receipt of a message configured to request performing of the packet data convergence protocol entity re-establishment procedure.

58. An apparatus comprising:
at least one processor; and
at least one non-transitory memory including computer program code;
the at least one memory and the computer program code configured to, with the at least one processor, cause the apparatus at least to:
transmit, to a user equipment, an uplink data compression configuration, wherein the uplink data compression configuration configures one or more data radio bearers to support uplink data compression for the user equipment without initial uplink data compression operation activation;
receive, from the user equipment, an indication to activate at least one data radio bearer of the one or more data radio bearers with uplink data compression configured for uplink data compression operation; and
in response to the indication, at least one of:
perform, locally, a packet data convergence protocol entity re-establishment procedure associated with the at least one data radio bearer, or
inform the user equipment to perform a packet data convergence protocol entity re-establishment procedure associated with the at least one data radio bearer.

59. The apparatus of claim 58, wherein the uplink data compression configuration comprises at least one of:
a predefined dictionary for uplink data compression, or
a buffer size for uplink data compression.

60. The apparatus of claim 58, wherein the at least one memory and the computer program code are configured to, with the at least one processor, cause the apparatus to: inform the user equipment to perform the packet data convergence protocol entity re-establishment procedure for the at least one data radio bearer, comprising causing the apparatus to:
transmit a message to the user equipment, wherein the message comprises an information element configured to indicate uplink data compression operation activation for the at least one data radio bearer, wherein the message comprises at least one of:
a radio resource control reconfiguration message,
a medium access control control element, or
downlink control information.

61. The apparatus of claim 60, wherein the at least one memory and the computer program code are configured to, with the at least one processor, cause the apparatus to:
activate the at least one data radio bearer for uplink data compression operation.

62. The apparatus of claim 60, wherein activating the at least one data radio bearer for uplink data compression operation comprises the at least one memory and the computer program code are configured to, with the at least one processor, cause the apparatus to:
deactivate a data radio bearer for uplink data compression operation according to the indication received from the user equipment.

63. The apparatus of claim 60, wherein the radio resource control reconfiguration message comprises a flag configured to indicate that the packet data convergence protocol entity re-establishment procedure is for uplink data compression operation activation only.

64. The apparatus of claim 58, wherein the at least one memory and the computer program code are configured to, with the at least one processor, cause the apparatus to: perform, locally, the packet data convergence protocol entity re-establishment procedure associated with the at least one data radio bearer in response to at least one of:
a time of receipt of the indication, or
expiration of a timer.

65. The apparatus of claim 58, wherein the at least one memory and the computer program code are configured to, with the at least one processor, cause the apparatus to:
receive, from the user equipment, a data protocol data unit using uplink data compression via one or more of the at least one data radio bearers with activated uplink data compression operation.

66. The apparatus of claim 58, wherein the indication comprises at least one of:
an uplink radio resource control message,
an indication of a data radio bearer identifier for respective ones of the at least one data radio bearer,
an information element of the uplink radio resource control message, wherein the information element comprises a list of data radio bearer identifiers for the at least one data radio bearer,
a field of a physical uplink shared channel medium access control control element, wherein the field comprises the list of data radio bearer identifiers for the at least one data radio bearer,
a field of a packet data convergence protocol or service data adaptation protocol control frame,
wherein the field comprises the list of data radio bearer identifiers for the at least one data radio bearer,
a flag of a packet data convergence protocol or service data adaptation protocol head of data physical data unit for the respective ones of the at least one data radio bearer, wherein the flag is configured to indicate whether uplink data compression operation for the respective ones of the at least one data radio bearer are to be activated or deactivated, or
a user plane control physical data unit.
